(19) United States
(12) Patent Application Publication
(10) Pub. No.: US 2005/0246234 A1
(43) Pub. Date: Nov. 3, 2005

(54) Automatic purchase categorization system

(76) Inventor: Stephen Munyon, Panama City, FL (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/108,428

(22) Filed: Apr. 18, 2005

Related U.S. Application Data
(60) Provisional application No. 60/563,257, filed on Apr. 16, 2004.

(51) Int. Cl. G06F 17/60

(52) U.S. Cl. 705/21

(57) ABSTRACT

A purchase tabulating system and method that can transmit UPC (bar code) information to a database so actual products purchased can be stored in the database. Information from the database can be used at a later time, such as for automatic insertion into tax preparation, accounting, or bookkeeping software.

### CROSS REFERENCE TO RELATED APPLICATIONS

This application claims benefit to provisional application No. 60/563,257, entitled, “Virtual Tax Assistance System,” filed on Apr. 16, 2004, which is incorporated by reference herein in its entirety.

### BACKGROUND OF THE INVENTION

1. Field of the Invention

The present invention is directed to a method, device, and computer readable storage medium for a virtual transaction tracking system for use in assisting individuals in tracking tax related transactions. In particular, the present invention is directed to a system for tracking business information for tax purposes and for generating related tax documents and schedules.

2. Background of the Invention

One of the most time consuming and complicated aspects of modem life is the compilation of business records for taxes. This is a particular problem for small business and entrepreneurs. While there is software on the market such as Quick Books and Peachtree Software, these products are often complicated and require access to a personal computer. These systems are of little assistance in maintaining records which are recorded on credit cards and the like. Frequently, small businessmen and entrepreneurs use a number of credit cards, including personal cards when transacting business for their companies. This often leads to inaccurate record keeping.

There is a need for a system which can easily compile and store business records for tax purposes. In particular, there is a need for a system which can compile and track information from a wide variety of sources. There is a particular need to provide a system which can compile tax related business information and to place that information on schedules and the like.

There have been a number of patents directed to the area of tax systems Other patents also disclose various types of point-of-sale tax tracking systems. U.S. Pat. No. 5,335,169 discloses a computerized system for tracking multiple types of sales tax assessments for different taxing authorities on different types of sales transactions with customers has a programmed operation which includes: (a) a support file maintenance interface for maintaining support files for different tax types, taxing authorities, tax rates, customers, and sales types; (b) a sales entry interface for entering sales orders into the system by customer identification number, sales type code, and sales amount; (c) a sales recording module for creating a sales record corresponding to each sales order entered including the customer data obtained from the customer support file indexed to the customer identification number and a sales tax amount as computed by application of the tax rate designated in the customer support file to the sales amount for sales that are not tax-exempt; and (d) a sales tax reporting module for sorting the sales records by tax authorities, tax types, and sales types, and for creating a sales tax report for each tax authority showing total sales and tax amounts for taxable sales, and total sales amount for non-taxable and exempt sales. Definition of the tax type in a support file as exempt allows the system to bypass the computation of a sales tax amount and to report the exempt sales amount.

U.S. Pat. No. 6,078,899 discloses a point of sale tax reporting and automatic collection system including a smart tax register located at a retailer location. The retailer smart register processes consumer transactions and calculates the amount of sales tax due the retailer by the consumer for each transaction. Following the transaction, the consumer requests and is give a tax paid receipt. After the sales tax is paid to the retailer by the consumer, the register either immediately or periodically forwards the amount of the transaction and the amount of sales tax collected by the retailer to a computer and memory located at a remote location (e.g. state government taxing authority). The computer and memory receive and store the retailer's transaction and sales tax information, and report same to the Internal Revenue Service at least once a year. After receiving the retailer's sales tax information, the computer accesses and debits an account belonging to the retailer, the amount debited corresponding to the amount of sales tax collected by the retailer. In sum, the system automatically reports all retailer transactions and sales tax collected by retailers from consumers to local and federal government authorities and then automatically collects the sales tax amounts from retailer accounts so as to prevent retailers from turning over the collected sales tax. A tax paid receipt is given to each consumer as evidence that the tax paid will be turned over to the proper authorities.

U.S. Pat. No. 5,774,872 discloses an automated transaction tax reporting/collection system. The system includes individual point of sale terminals disposed at each remote vendor location. The point of sale terminals are networked to a central computer, preferably via a plurality of intermediate data collection sub-stations. Each terminal includes means for inputting and storing data regarding taxable transactions, as well as for storing data reflecting the tax accrued on each transaction. This stored data is collected on a periodic, rotating basis by the corresponding data collection sub-station according to control signals generated by the central computer. All of the collected data is ultimately transmitted to the central computer, which is operative to generate reports reflecting the transaction tax due from each remote vendor location. These reports may then be sent to the taxing authority, the individual merchants, and/or to other taxing authorities, such as the federal government. Preferably, each point of sale terminal also includes a printer which prints an official tax receipt for each transaction recorded.

While there have been systems and technologies for assisting companies in tracking taxes, there have been no systems for automating tax information. It would be desirable to provide a system and mechanism by which tax information can be compiled and stored.

### SUMMARY OF THE INVENTION

It is an aspect of the present invention to provide a system which can automate record keeping and categorization of purchases.

The above aspects can be attained by a method that includes (a) processing a credit card transaction for a product purchase; (b) transmitting transaction information to a transaction database, the transaction information comprising a UPC code for the product; (c) retrieving transaction information from the transaction database; (d) categorizing the transaction information using the UPC code into categorized information; and (e) outputting the categorized information.

The above aspects can also be attained by a method that includes (a) processing a credit card transaction for a product purchase; (b) specifying, by a purchaser of the product, a code; (c) transmitting transaction information to a transaction database, the transaction information comprising the code; (d) retrieving transaction information from the transaction database; (e) categorizing the transaction information using the code into categorized information; and (f) outputting the categorized information.

These and other objects of the present invention will be apparent from the detailed description which follows. These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Reference will now be made in detail to the presently preferred embodiments of the invention, examples of which are illustrated in the accompanying drawings, wherein like reference numerals refer to like elements throughout.

FIG. 1 is a block diagram illustrating components of the present invention, according to an embodiment;

FIG. 2 is an end user entry screen, according to an embodiment;

FIG. 3 is an end user screen illustrating tax paying entities, according to an embodiment;

FIG. 4 is a diagram of purchases and taxes for a particular entity, according to an embodiment;

FIG. 5 illustrates a screen to create a tax document, according to an embodiment; and

FIG. 6 is an exemplary flowchart illustrating a method to implement the present invention, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The invention is directed to a virtual tax document system which may be integrated with existing credit and debit card systems or future variations thereof.. The system tracks, collects, and stores the purchases of a person, as well as pertinent information relevant to tax obligations. This system would enable its users to segregate their tax-liable and tax-exempt purchases and later to calculate their tax obligations. This system could be implemented through credit, debit, or cash purchases through the use of a personal code or an encoded card. The system can also be used to create budgets.

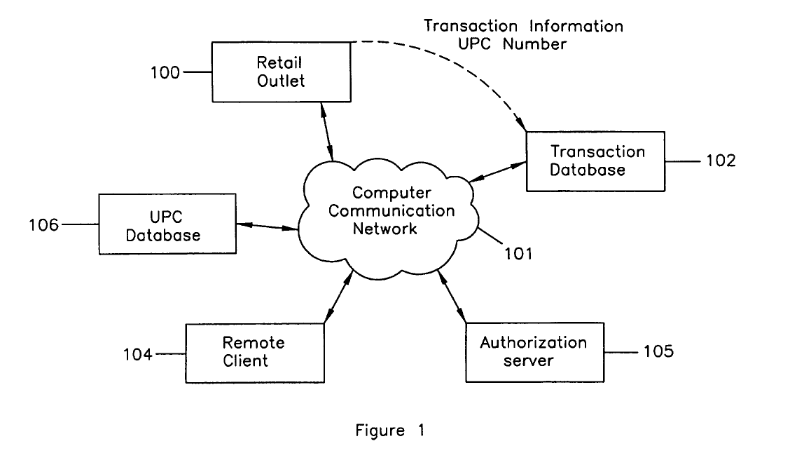

The present invention is described with reference to the enclosed Figures wherein the same numbers are utilized where applicable. Referring to FIG. 1, the invention is broadly directed to a system for compiling information for tax purposes. The system tracks and collates end user purchases and expenditures for tax purposes.

FIG. 1 is a block diagram illustrating components of the present invention, according to an embodiment.

A computer communications network 101 (for example the Internet) can be used to facilitate communication between components herein. Further additional computer communication network(s) (not pictured) can be used to connect components as well in addition to or in place of the computer communications network 101.

A retail outlet 100 can process a credit card purchase. A purchaser typically presents his or her credit card to the retail outlet 100 that will scan the card and then transmit an authorization request an authorization server 105. The authorization server 105 is used to verify the credit card number and generate an approval code, as known in the art.

A transaction database 102 can be used to receive transaction information and store the transaction information for later retrieval. The transaction information transmitted to the transaction database 102 from the retail outlet 100 can comprise any information related to the purchase, which can include purchase amount, UPC code for each product purchased, time, date, credit card number used, special account number, other code specified by the purchaser, etc. The transaction database 102 can store the transaction information for later retrieval and can be a database such as an SQL based database.

A remote client 104 can be used to perform a number of operations, such as tax preparation, transaction retrieval, checkbook balancing, etc. The remote client can retrieve transaction data from the transaction database 102 based on a credit card number (or other identifying information). For example, all (or some) purchases made by a particular credit card can be retrieved, along with their respective UPC numbers. This can be useful so that an application can categorize different purchases by their UPC number. For example, all food purchases and all computer equipment purchases can be separated based on their UPC number. A purchaser can also specify a particular code that the casher can enter into the system which can also be used in place of (or in addition to) the UPC number. For example, a particular code can be for business purchases and another code can be for personal purchases, etc. As another example, the particular code can be used to direct a particular item or items to a particular line on a tax return (which may be used for deduction purposes). The code can also be used to direct items to a correct tax return, thus multiple businesses can use different tax returns and items will automatically be directed to the proper return based on the code.

The described methods can be helpful, for example, if a party wants to know how much was spent on computer equipment purchases. Previously, the way to do this was to review each purchase individually and determine which purchases qualify. With the present invention, any purchase that has a particular UPC number (e.g. which is considered computer equipment) can be automatically identified and tabulated.

A UPC database 106 can be used by the remote client 104 (and any other component) in order to properly categorize UPC numbers. For example, certain numbers can be associated with certain goods. Table I illustrates one example of a table of UPC numbers and respective goods.

TABLE I

| UPC Number | goods |
|---|---|
| 123 | computer equipment |
| 125 | computer equipment |
| 003 | cosmetics |
| 004 | restaurant food |

Note that instead of a word in the “goods” column, another number can be used in addition (or in place of) to designate a category of goods. For example, computer equipment can be assigned a category of “9000.” This can be mapped to a category as needed at a later time.

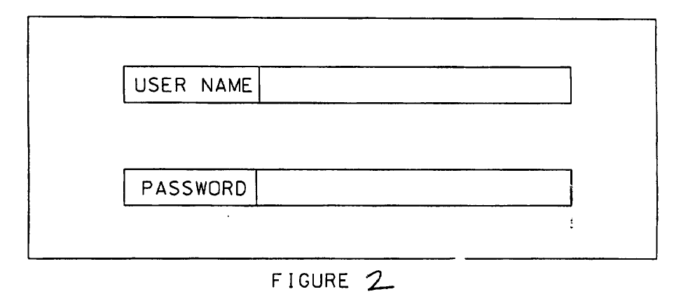

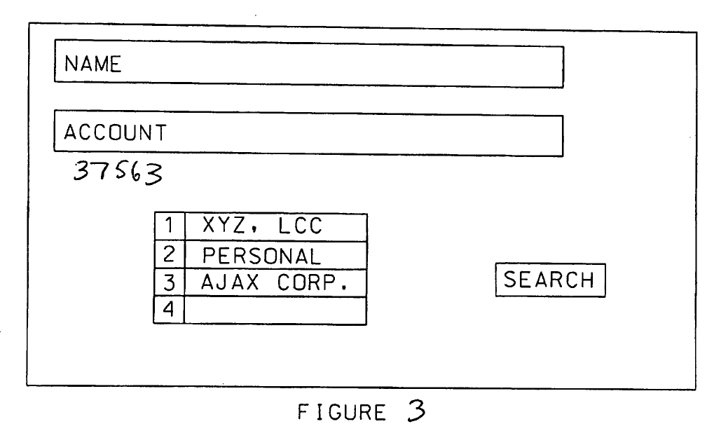

The end user can access the interface via a password protected interface as shown in FIG. 2. The interface then leads to a series of input screens which enable the end users to access data and to generate reports. The screens showed in FIGS. 2 to 4 permits the end user to easily track business sales. The invention thus comprises a system which tracks the purchases for individual businesses.

As purchases are made, the system will track the purchase, vendor, price and the taxes and upload them to the online system. The system can further provide a code which will authenticate that the purchase was real and authentic.

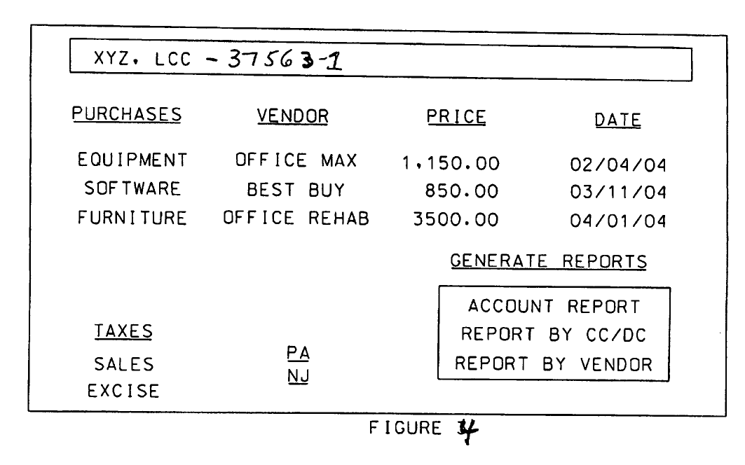

The invention thus improves over existing system for tracking tax related information, while also nearly eliminating the itemizing of purchases, tracking of receipts, organization of tax records. The invention facilitates a number of protocols and systems (i.e. UPC, POS systems, CC/DC swipe terminals, etc.) to upload the data. As shown in FIG. 4, the invention collects, stores, and automates tax information about purchased products or services, including but not limited to product/service sector/category, tax rate, tax type (local, state, federal), cost of product, time of purchase, and purpose of purchase (i.e. personal or business), and more is transferred from the point of purchase to either a central holding or automatically distributed to an assigned location which will store/house the information the for the use of creating a track of sales to later create a “virtual” tax document or spending report. Fees and commissions can be paid to the credit card issuers, banks, etc which participate in the system.

The entity ID number may be entered at the point of purchase in order to indicate which entity a particular group of purchases relate. For example, if businessman Mr. Smith has selected fifteen items to purchase from his local hardware store and is now ready to check out. He allows the cashier to scan six of those items and then can give her the code 37563 to type in which would indicate personal expenses. Mr. Smith then allows the cashier to scan nine more items and asks her to type in another code indicating a first business. Mr. Smith's credit card/debit card is then swiped in normal fashion and with a signature the transaction is complete.

This system is also possible with cash transactions, through existing or future protocols, a VTD card can be issued. Using current or future in place swipe card system(s) can be put in place to follow cash purchases allowing the purchase information to be routed to the individual's tax file.

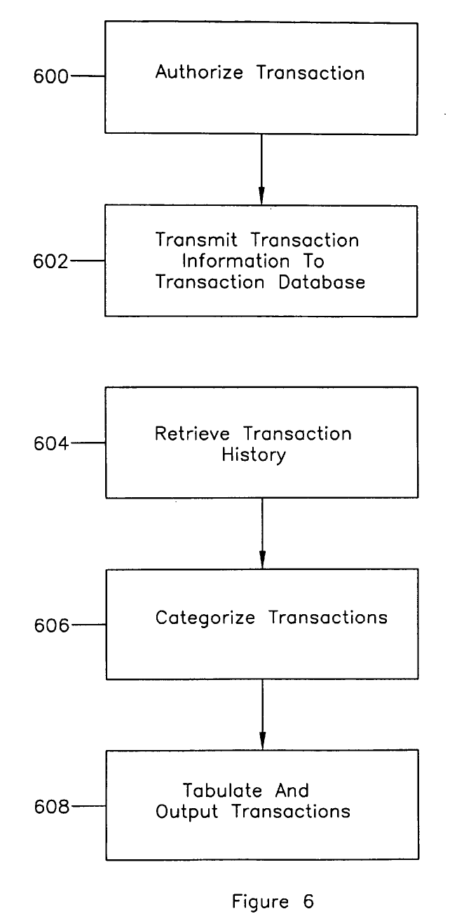

FIG. 6 is an exemplary flowchart illustrating a method to implement the present invention, according to an embodiment.

The method can first begin with operation 600, which processes the transaction. This can be performed as known in the art. A credit card purchase is made wherein the credit card number and the amount are transmitted to an authorization server, which checks whether the credit card number is valid and whether the requested amount is available (and any other security operations).

From operation 600, the method can proceed to operation 602, which transmits transaction information to transaction database. The transaction information can be identical to information transmitted to the authorization server but also including a UPC number, or the transaction information may be different. The transaction information can typically comprise a UPC number, an amount, a time, a date, a credit card number used, a special identification number, etc. Any of the previous fields may be optional, and any combination of fields can be used (including additional fields known in the art not mentioned herein). If multiple items are purchased, then the UPC number for each individual item can be transmitted along to the transaction database. The price of each individual item can be comprised in the transaction information as well.

Thus, for every purchase (or item purchased), operations 601 to 602 are performed, which maintains records of each purchase in a database.

After a credit card is authorized in operation 600, if a number of items are purchased, the entire block of items (which can include the UPC code for each item, price at the store, time, date, special category, etc.) can then be transmitted to the transaction database. The transaction database may typically (although not required to be) a different database than used by the credit card processor (e.g. Visa, etc.) and is maintained for the purpose of facilitating the user's record keeping.

When a user wishes to utilize the information stored in the database, operations 604-608 can be performed.

Operation 604 retrieves transaction history from the transaction database using a remote client. This can be performed by using a username/password and optionally transmitted a credit card account number and optionally transmitting a date range. A sequence of transactions can be transmitted to the client.

From operation 604, the method can proceed to operation 606, which categorizes the transactions. The transactions can be categorized by their respective UPC numbers (retrieved in operation 604). A UPC database (or internal table) can be used to match UPC numbers with their product (or service) category. For example, the UPC database can return that a particular UPC number is for computer equipment.

Transactions can be categorized as needed. For example, for tax purposes, items can be categorized as whether they can be deducted or not. For example, computer equipment may (according to a tax preparation software) be deductible, so all purchases in which a UPC code which relates to computer equipment can be categorized as such and possibly automatically itemized in tax preparation software.

From operation 606, the method can proceed to operation 608, which can tabulate and output transactions. Data retrieved (in operation 604) and categorized (in operation 606) as being of a particular type can then be outputted for a special use. For example, computer purchases can be outputted in a special file for use as tax deductions automatically. A tax preparation software module can run on a remote client and access the transaction database, automatically categorize transactions relevant to the person's accounting and bookkeeping needs, and automatically import relevant data for those purchases into the proper portions of the tax return.

Other tabulations can be used, such as categorizing purchases into different groups so that a purchaser can balance and review his or her expenditures. For example, purchases for entertainment and for household goods can be automatically categorized and outputted so that a user can see where his or her money is being spent.

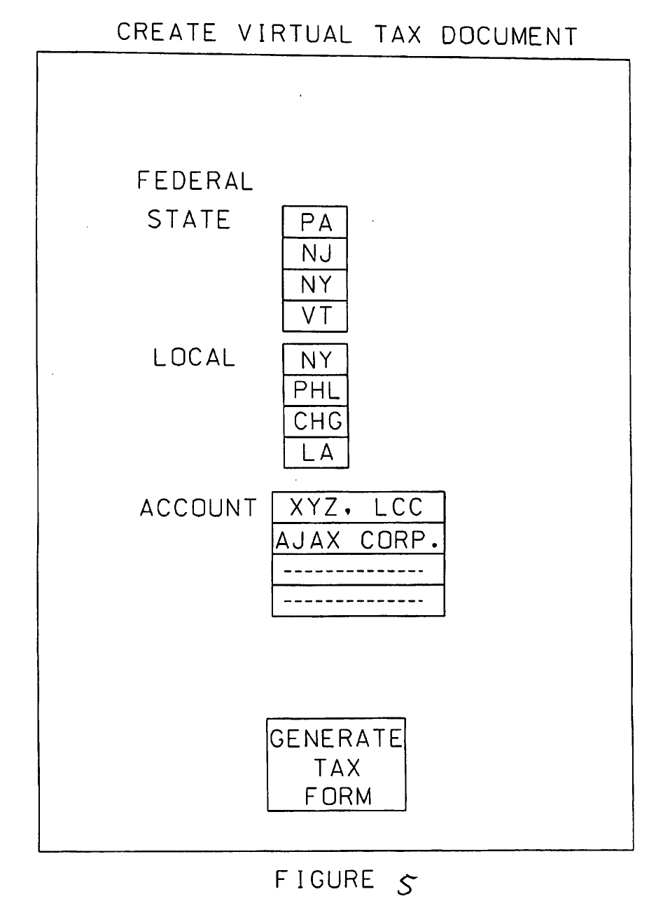

One of the features of the invention is its ability to create tax return schedules of the kind used in local, state and federal returns. As shown in FIG. 5, the system can match purchases to specified taxpayers (individual and businesses) in order that the purchase is routed to the correct line on a tax or budget document. Purchases that are rejected will be highlighted (e.g. on a master receipt) and left for the company or individual's accountant to examine. The master receipt should typically contain all of the purchases. Multiple products or services can be purchased during the same transaction and routed to one or more of several Tax Documents by entering the code after the scanning of one or more items in the group. The code will indicate the correct tax document for that particular purchase or group of purchases (e.g. local, state, federal). The invention can assist any entity which has a need for budgeting or itemizing for personal business or tax purposes.

Table II below illustrates one example of a categorization for purchases, according to an embodiment of the present invention.

TABLE II
Personal Goods

| Date | Time | Item | Price | Store | UPC number |
|---|---|---|---|---|---|
| Jan. 1, 2003 | 13:00 | toothpaste | $1.99 | ACME | 005 |
| Jan. 1, 2003 | 13:00 | hairbush | $1.40 | ACME | 134 |
| Jan. 1, 2003 | 15:34 | razor | $0.99 | Z-Mart | 159 |
| Jan. 29, 2003 | 3:21 | mouthwash | $1.25 | ACME | 087 |
| Jan. 1, 2003 | 13:00 | LCD display | $899 | ACME | 123 |
| Jan. 20, 2003 | 18:21 | power supply | $29 | Video | 125 |
| | | | | Shack | |

The example illustrated in Table II is just merely one example of categorizing data. Note that the price amount can be transmitted from the retail outlet itself to the transaction database, while the category for each UPC number can be retrieved from a local list (such as that exemplified in Table I) or other database. Note that certain categories (e.g. computer equipment) can be exported to a software package, such as a tax preparation document. The exportation can be done using any known protocol, such as XML.

Note that instead of (or in addition to) transmitting UPC numbers upon purchase, another code (as described above) can also be given to the cashier (spoken or on a physical card) so that the cashier can indicate the number along with the item(s) purchased so the code can be properly transmitted to the transaction database so it can possibly be used later for categorization.

The invention thus provides a personal/business federal/state/local income tax and budget system which routes, categorizes and stores all pertinent information regarding any/all purchase/purchases, regardless of payment method, using credit/debit card systems or any future variation thereof.

The methods herein can also be stored on a computer readable storage medium, such as a CD-ROM, etc., which can store a program to execute such methods. The invention also includes hardware and any apparatus needed to implement the methods described herein.

The present invention has been described in accordance with the preferred embodiment. It is to be noted that other embodiments fulfill the spirit and scope of the present invention and that the true nature and scope of the invention is to be determined with reference to the claim appended hereto.

1. A purchase tabulating method, comprising:
processing a credit card transaction for a product purchase;
transmitting transaction information to a transaction database, the transaction information comprising a UPC code for the product;
retrieving transaction information from the transaction database;
categorizing the transaction information using the UPC code into categorized information; and
outputting the categorized information.

2. A method as recited in claim 1, wherein the outputting outputs the categorized information to a tax preparation module.

3. A method as recited in claim 1, wherein the categorized information is outputted to a third party software application.

4. A method as recited in claim 1, further comprising:
specifying a code for the transaction upon purchase, so that the purchase can be categorized by respective code.

5. A purchase tabulating method, comprising:
processing a credit card transaction for a product purchase;
specifying, by a purchaser of the product, a code;
transmitting transaction information to a transaction database, the transaction information comprising the code;
retrieving transaction information from the transaction database;
categorizing the transaction information using the code into categorized information; and
outputting the categorized information.

6. A method as recited in claim 5, wherein the outputting outputs the categorized information to a tax preparation module.

7. A method as recited in claim 5, wherein the categorized information is outputted to a third party software application.

8. A method as recited in claim 5, further comprising:
specifying a code for the transaction upon purchase, so that the purchase can be categorized by respective code.

9. A method as recited in claim 5, wherein the transaction information comprises a UPC code for the product purchase.

10. A method as recited in claim 5, further comprising:
using the code to direct the transaction information to a particular tax return.
